(19) United States
(12) Patent Application Publication
(10) Pub. No.: US 2011/0007224 A1
(43) Pub. Date: Jan. 13, 2011

(54) PROJECTOR

(75) Inventor: TZU-CHENG YU, Shindian (TW)

Correspondence Address: Altis Law Group, Inc.;ATTN: Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/764,188

(22) Filed: Apr. 21, 2010

(30) Foreign Application Priority Data
Jul. 8, 2009 (CN) 200910304150.0

(51) Int. Cl. H04N 9/31; H04N 5/63

(52) U.S. Cl. 348/730; 348/744; 348/E05.127; 348/E09.025

(57) ABSTRACT

A projector for showing images displayed by an electronic device includes a projecting unit and a power supply unit. The projecting unit is connected to the electronic device to receive signals from the electronic device and show the images according to the signals. The power supply unit is connected to the projecting unit to supply electric power to the projecting unit. The power supply unit includes a power output connector and outputs electric power through the power output connector.

### BACKGROUND

1. Technical Field

The present disclosure relates to projectors, and particularly to a projector capable of supplying electric power to other electronic devices.

2. Description of Related Art

Many projectors are used to project images from personal computers (PC) to enlarged sized display screens. Generally, when a projector is connected to a PC to show images, the projector and the PC need to be respectively connected to different power supplies to receive electric power. These connecting operations may be complicated and time consuming.

Therefore, there is room for improvement within the art.

### BRIEF DESCRIPTION OF THE DRAWINGS

Many aspects of the present projector can be better understood with reference to the following drawings. The components in the various drawings are not necessarily drawn to scale, the emphasis instead being placed upon clearly illustrating the principles of the present projector. Moreover, in the drawings, like reference numerals designate corresponding parts throughout the figures.

FIG. 1 is a block diagram of a projector, according to a first exemplary embodiment.

FIG. 2 is a block diagram of a projector, according to a second exemplary embodiment.

### DETAILED DESCRIPTION

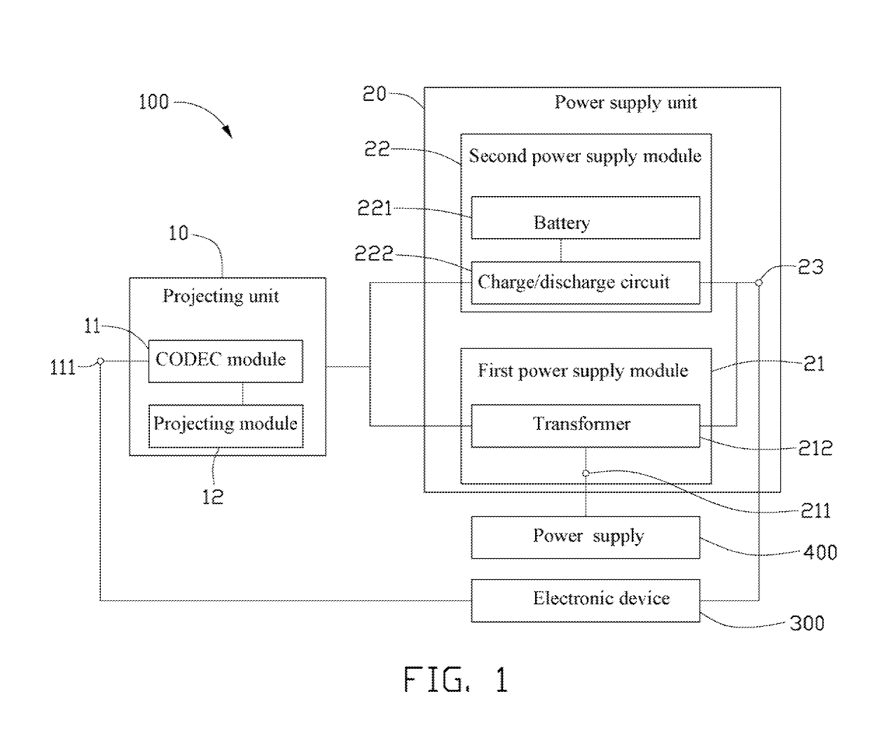

FIG. 1 shows a projector 100, according to a first exemplary embodiment. The projector 100 includes a projecting unit 10 and a power supply unit 20 electrically connected to the projecting unit 10. The projecting unit 10 can be connected to an electronic device 300 capable of displaying images, such as a personal computer (PC), to project images displayed by the electronic device 300 to enlarged sized display screens. The power supply unit 20 can provide electric power to the projecting unit 10, and can also be used to charge the electronic device 300 that is used for displaying images.

The projecting unit 10 includes a coder/decoder (CODEC) module 11 and a projecting module 12 electrically connected to the CODEC module 11. The CODEC module 11 has an interface 111, which can be a universal serial bus (USB) interface. The projector 100 can be connected to the electronic device 300 via the interface 111. The projecting module 12 includes conventional optical mechanisms and projecting circuits. In use, image signals are transmitted from the electronic device 300 to the CODEC module 11 through the interface 111. The CODEC module 11 decodes the signals and transmits the decoded signals to the projecting module 12. The projecting module 12 shows images according to the decoded signals.

The power supply unit 20 includes a first power supply module 21, a second power supply module 22, and a power output connector 23. The first power supply module 21 includes a power supply connector input 211 and a transformer 212 connected to the power supply connector input 211 and the projecting unit 10. The power input connector 211 can be connected to conventional power supplies, such as plug receptacles, such that electric power can be input to the projector 10 through the power input connector 211. The transformer 212 can regulate the electric potential of the input electric power to predetermined values.

The second power supply module 22 includes a rechargeable battery 221 and a charge/discharge circuit 222 connected to the battery 221. The charge/discharge circuit 222 and the transformer 212 are electrically connected to each other, and are both electrically connected to projecting unit 10 and the power output connector 23.

When the projector 100 is used, the projecting unit 10 is connected to the electronic device 300 via the interface 111, and the power output connector 23 is also connected to the electronic device 300. Thus, image signals can be transmitted from the electronic device 300 to the CODEC module 11 through the interface 111 to be decoded, and the projecting module 12 can show images according to the decoded signals. The projector 100 and the electronic device 300 can receive working electric power using two methods. If the power input connector 211 is not connected to any external power supply, the battery 221 is used to supply electric power to the projecting unit 10 through the charge/discharge circuit 222. If the power input connector 211 is connected to an external power supply 400, such as a plug receptacle, the power supply 400 is used to supply electric power to the projecting unit 10 through the transformer 212. When the projector 100 is used, the power supply 400 can also recharge the battery 221 through the transformer 212 and the charge/discharge circuit 222. Furthermore, the battery 221 can also supply electric power to the electronic device 300 through the charge/discharge circuit 222 and the power output connector 23, and the power supply 400 connected to the power input connector 211 can also supply electric power to the electronic device 300 through the transformer 212 and the power output connector 23.

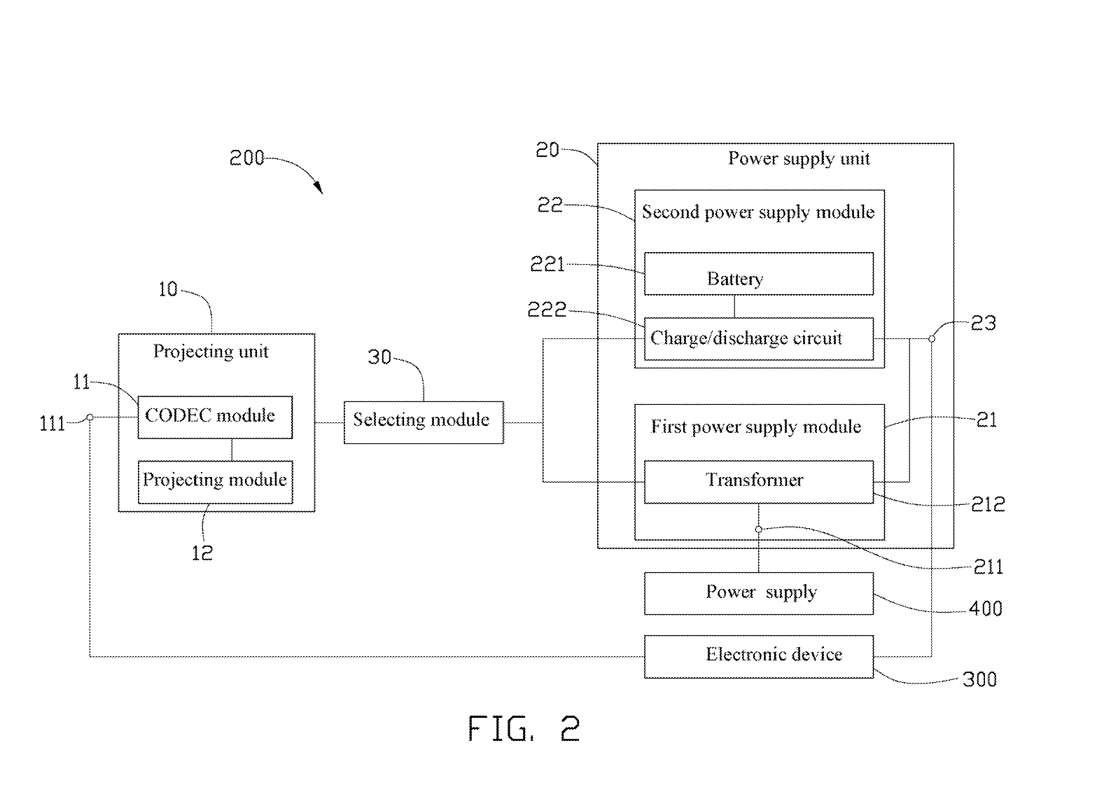

FIG. 2 shows a projector 200, according to a second exemplary embodiment. The projector 200 is similar to the projector 100, except that it further comprises a selecting module 30. The charge/discharge circuit 222 and the transformer 212 are both connected to the projecting unit 10 through the selecting module 30. The selecting module 30 can be a select switch. In use, the projecting unit 10 can be selectively connected to either of the transformer 212 and the charge/discharge circuit 222 through the selecting module 30, thereby selectively receiving electric power from power supplies (e.g., the power supply 400) connected to the power input connector 211 or the battery 221.

When the projector 100/200 is connected to the electronic device 300 to present images displayed by the electronic device 300 to enlarged sized display screens, the power supply (i.e., the power supply 400 connected to the power input connector 211 or the battery 221) of the projector 100/200 can be connected to the electronic device 300 through the projector 100/200 and supply electric power to the electronic device 300. Therefore, the electronic device 300 used for displaying images can share the power supply of the projector 100/200 and needs not to be connected to other power supplies. Additionally, the electronic device 300 used for displaying images can also be connected to other power supplies to receive electric power, and thus the power output connector 23 can be connected to another rechargeable battery (not shown) to charge the battery using electric power of the power supply of the projector 100/200.

It is to be further understood that even numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A projector for showing images displayed by an electronic device, comprising:
a projecting unit connected to the electronic device to receive signals from the electronic device and show the images according to the signals; and
a power supply unit connected to the projecting unit to supply electric power to the projecting unit; wherein the power supply unit includes a power output connector and outputs electric power through the power output connector.

2. The projector as claimed in claim 1, wherein the power supply unit includes a first power supply module connected to the projecting unit and the power output connector, the first power supply module configured for connecting an external power supply and transmitting electric power of the external power supply to the projecting unit and the power output connector.

3. The projector as claimed in claim 2, wherein the first power supply module includes a power input connector connected to the external power supply and a transformer connected to the power input connector, the projecting unit, and the power output connector.

4. The projector as claimed in claim 2, wherein the second power supply module includes a battery and a charge/discharge circuit connected to the battery, the projecting unit, and the power output connector for transmitting electric power of the battery to the projecting unit and the power output connector.

5. The projector as claimed in claim 4, wherein the first power supply module is connected to the charge/discharge circuit to charge the battery using the electric power of the external power supply.

6. The projector as claimed in claim 4, further comprising a selecting module, the first power supply module and the second power supply module both connected to the projecting unit through the selecting module, the projecting unit selectively connected to either of the first power supply module and the second power supply module through the selecting module, thereby selectively receiving electric power from the external power supply or the battery.

7. The projector as claimed in claim 1, wherein the power output connector is connected to the electronic device displaying images to supply electric power to the electronic device.
